(19) United States
(12) Patent Application Publication
(10) Pub. No.: US 2006/0222146 A1
(43) Pub. Date: Oct. 5, 2006

(54) Solids detector for shooting X-ray images

(76) Inventor: Martin Spahn, Erlangen (DE)

Correspondence Address: HARNESS, DICKEY & PIERCE, P.L.C., P.O.BOX 8910, RESTON, VA, 20195, US

(21) Appl. No.: 11/391,380

(22) Filed: Mar. 29, 2006

(30) Foreign Application Priority Data
Mar. 30, 2005 (DE) 10 2005 014 443.8

(51) Int. Cl. H05G 1/64

(52) U.S. Cl. 378/98.8

(57) ABSTRACT

To increase the independence of an X-ray system, a solids detector, particularly a transportable, wireless solids detector, is disclosed for shooting X-ray images of an examination object irradiated by X-ray radiation. The detector includes an active pixel matrix for reading raw X-ray images and an image preprocessing unit for electronically correcting the raw X-ray images.

The present application hereby claims priority under 35 U.S.C. §119 on German patent application number DE 10 2005 014 443.8 filed Mar. 30, 2005, the entire contents of which is hereby incorporated herein by reference.

### FIELD

The invention generally relates to a solids detector for shooting X-ray images.

### BACKGROUND

Solids detectors for X-ray imaging which are based on active reading matrices, e.g. made of amorphous silicon (a-Si), have been known for some years. Image information is converted in an X-ray converter, e.g. cesium iodide (CsI), is stored as an electrical charge in photodiodes in the reading matrix and is then read using an active switching element with dedicated electronics and is subject to analog-digital conversion. In addition, transportable, wireless solids detectors are also known which can be positioned separately from an ordinary X-ray system, that is to say a central controller, an X-ray source and an image system. Such transportable solids detectors have an integrated power supply and wirelessly transmit data from raw X-ray images which have been shot, for example by radio.

Before raw X-ray images can be processed further, a few effects caused by the specific properties of the respective solids detector need to be corrected electronically using an image preprocessing unit. Each solids detector has properties which vary from pixel to pixel, such as dark currents, leakage currents or pixel capacitances. In addition, each reading channel likewise has different properties as a result of different line capacitances, input capacitances in the input amplifier and the like. Furthermore, residual image effects also arise, that is to say residual signals which are left over from a preceding X-ray image. The most important electronic corrections which are performed to eliminate such effects are offset corrections, gain corrections and fault corrections.

The electronic corrections are performed outside of the detector in an image system integrated in the X-ray system or in an image preprocessing unit connected upstream of the image system. By way of example, the electronic correction involves an offset correction image, which contains exclusively background effects and has been shot by the solids detector in one phase without the presence of X-ray radiation, being electronically deducted from the raw X-ray image. Correction images are frequently renewed and transmitted to the X-ray system.

U.S. Pat. No. 6,433,652 B1 discloses a cassette with a digital X-ray detector on a solids basis which has a display unit, a unit for storing the X-ray image which has been read and connections to external appliances. The cassette may also have an image editing unit which performs editing processes such as altering the size of the image or normalizing the image (EDR=Exposure Data Recognition).

### SUMMARY

It is an object of at least one embodiment of the present invention to provide a solids detector which is independent of an X-ray system, particularly a transportable solids detector.

At least one embodiment of the invention achieves an object by way of a solids detector for shooting X-ray images.

The image preprocessing unit for electronically correcting raw X-ray images which has been physically integrated into the, particularly transportable, solids detector by at least one embodiment of the invention ensures that the solids detector is independent of an X-ray system and hence that the solids detector is made anonymous by virtue of the image preprocessing unit allowing electronic correction of raw X-ray images, so that the X-ray images resulting from the correction are free of detector-specific artifacts and effects. This allows the inventive solids detector to forward X-ray images, as appropriate, which are independent of its specific properties and can be processed further in any desired X-ray system or image system without further communication between the X-ray system and the solids detector.

In line with at least one embodiment of the invention, the image preprocessing unit has a memory unit for storing at least one correction image and a processing unit for electronically correcting the raw X-ray images using the at least one correction image.

In accordance with one particularly advantageous refinement of at least one embodiment of the invention, the solids detector in the form of a transportable solids detector has transmission and reception devices for wireless, two-way communication with an X-ray system. Such a solids detector can be associated with any desired, suitable X-ray system particularly flexibly, easily and with little complexity and can be removed again, or associated with another X-ray system, following the wireless transmission of X-ray images.

### BRIEF DESCRIPTION OF THE DRAWINGS

Embodiments of the invention and advantageous refinements thereof are explained in more detail below in the detailed description and using a schematically shown example embodiment in the drawings, without this limiting the invention to the example embodiment; in the drawings:

FIG. 1 shows a basic outline of method steps for correcting raw X-ray images based on the prior art; and

FIG. 2 shows a section through a side view of a transportable and wireless solids detector based on an embodiment of the invention with an image preprocessing unit.

### DETAILED DESCRIPTION OF THE EXAMPLE EMBODIMENTS

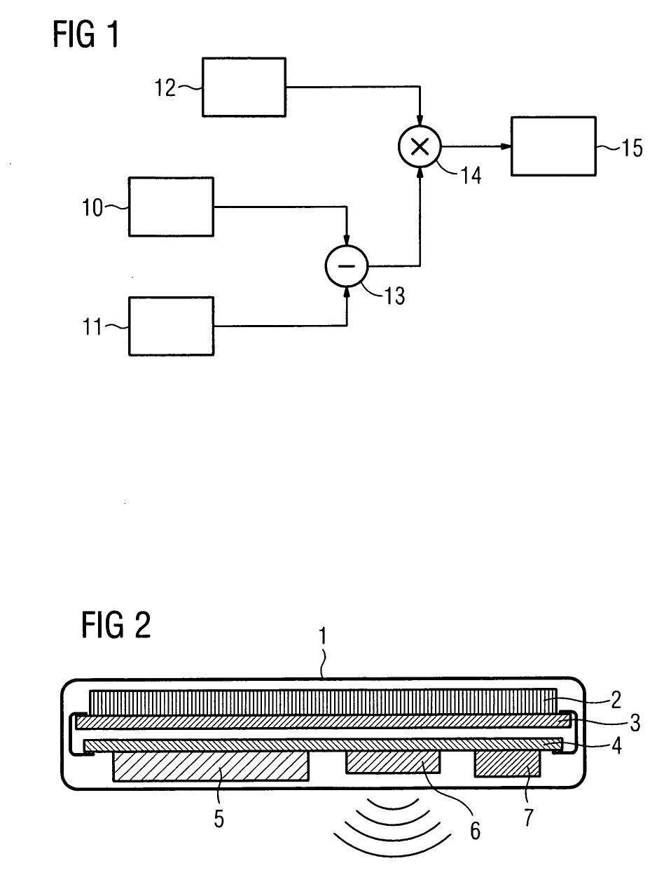

It is known practice from the prior art to eliminate artifacts arising on account of the specific properties of solids detectors by transmitting raw X-ray images 10, after they have been read by an active pixel matrix, from the solids detector to an image preprocessing unit integrated in an X-ray system for the purpose of image preprocessing. The image preprocessing involves a blank offset correction image 11 being shot and likewise transmitted to the image preprocessing unit integrated in the X-ray system for the purpose of image preprocessing in phases in which no raw X-ray image of an examination object is taken and without the presence of X-ray radiation. The offset correction image 11 is—as shown in FIG. 1—deducted from any subsequently shot raw X-ray image 10 using a subtraction method 13, is then subjected to a multiplication method 14 with a gain correction image 12, that is to say an image shot without the object but with the X-ray radiation, and is then available as an offset-corrected and gain-corrected X-ray image 15 for possible image postprocessing or output. Besides the offset correction and the gain correction, it is also possible to perform further corrections, for example correction of faulty pixels.

FIG. 2 shows a transportable digital solids detector 1 which, besides a scintillator layer 2, an active reading matrix 3, an electronics board 4, a power supply unit 7 and a transmission and reception unit 6 for wireless communication, contains an image preprocessing unit 5 as a design component, in line with the invention. Since electronic correction of raw X-ray images 10 is performed directly in the transportable solids detector 1 using the image preprocessing unit 5, the solids detector 1 based on the invention delivers X-ray images 15 which are independent of its specific properties. Time-consuming and energy-intensive transmission of correction images to an image system outside the detector or to an X-ray system therefore becomes superfluous. The solids detector 1, which is associated with an X-ray system for the purpose of shooting an X-ray image, can therefore be replaced particularly easily.

The image preprocessing unit 5 advantageously including a memory unit for storing at least one correction image and an editing unit for electronically correcting the raw X-ray image 10 using the at least one correction image 11; 12. Expediently, an electronic correction involves an offset correction and/or a gain correction and/or a fault correction. The electronic corrections are performed in a known manner using various correction algorithms.

The scintillator layer 2 is made of cesium iodide, for example, which is applied to the active reading matrix 3. The active reading matrix 3 has a multiplicity of pixels which each contain a photodiode and a switching element. The light signals which result from the penetration of X-ray radiation into the scintillator layer 2 are converted into electrical charge, are stored and are then read electronically. It is also possible for X-ray radiation to be converted into electrical charge using a direct converter layer.

The transportable solids detector 1 advantageously has a power supply unit 7, which is in the form of a storage battery, in particular, for independent supply of power. In accordance with one refinement of at least one embodiment of the invention, the transportable solids detector 1 has transmission and reception means 6 for wireless, two-way communication with an X-ray system. The transmission and reception device 6 for wireless communication are designed to send image data and to receive actuation signals and can enter into two-way communication with a transmission and reception unit in a central control unit of an X-ray system or of an image system, for example. Provision is made for the transmission and reception device 6 to be able to make contact with various X-ray systems in order to ensure that the transportable solids detector 1 can be used in different X-ray systems. The electronics board 4, the image preprocessing unit 5, the power supply unit 7 and the transmission and reception unit 6 are protected against incident X-ray radiation by a screening element (not shown).

In summary, at least one embodiment of the invention can be described as follows: to increase the independence of an X-ray system, a solids detector, particularly a transportable, wireless solids detector 1, for shooting X-ray images of an examination object irradiated by X-ray radiation has an active pixel matrix 3 for reading raw X-ray images 10 and an image preprocessing unit 5 for electronically correcting the raw X-ray images 10.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A solids detector for digital shooting of X-ray images of an examination object irradiated by X-ray radiation, comprising:
an active pixel matrix to read raw X-ray images; and
an integrated image preprocessing unit to electronically correct the raw X-ray images, the image preprocessing unit including a memory unit to store at least one correction image and a processing unit to electronically correct the raw X-ray images using the at least one correction image.

2. The solids detector as claimed in claim 1, wherein the solids detector is in the form of a transportable solids detector.

3. The solids detector as claimed in claim 2, wherein the transportable solids detector includes transmission and reception means for wireless, two-way communication with an X-ray system.

4. The solids detector as claimed in claim 2, wherein the transportable solids detector includes a power supply unit.

5. The solids detector as claimed in claim 1, wherein an electronic correction involves at least one of an offset correction, a gain correction and a fault correction.

6. An X-ray system, comprising:
a radiation source;
a central control device; and
a solids detector to shoot X-ray images of an examination object irradiated by X-ray radiation, the solids detector including an active pixel matrix to read raw X-ray images and an image preprocessing unit to electronically correct the raw X-ray images, the image preprocessing unit including a memory unit to store at least one correction image and a processing unit to electronically correct the raw X-ray images using the at least one correction image.

7. The solids detector as claimed in claim 2, wherein the transportable solids detector includes a storage battery.

8. The X-ray system of claim 6, wherein the solids detector is an associatable, transportable solids detector.

9. A solids detector for digital shooting of X-ray images of an examination object irradiated by X-ray radiation, comprising:
means for reading raw X-ray images; and
means, for electronically correcting the raw X-ray images, including memory means for storing at least one correction image and processing means for electronically correcting the raw X-ray images using the at least one correction image.

10. The solids detector as claimed in claim 9, wherein the solids detector is in the form of a transportable solids detector.

11. The solids detector as claimed in claim 10, wherein the transportable solids detector includes transmission and reception means for wireless, two-way communication with an X-ray system.

12. The solids detector as claimed in claim 10, wherein the transportable solids detector includes a power supply unit.

13. The solids detector as claimed in claim 9, wherein an electronic correction involves at least one of an offset correction, a gain correction and a fault correction.

14. An X-ray system, comprising:
a radiation source;
a central control device; and
means, for shooting X-ray images of an examination object irradiated by X-ray radiation, including means for reading raw X-ray images and means for electronically correcting the raw X-ray images, the means for electronically correcting including memory means for storing at least one correction image and a processing means for electronically correcting the raw X-ray images using the at least one correction image.

15. The solids detector as claimed in claim 10, wherein the transportable solids detector includes a storage battery.

16. The X-ray system of claim 14, wherein the means for shooting includes an associatable, transportable solids detector.

17. An X-ray system, comprising a solids detector as claimed in claim 1.

18. An X-ray system, comprising as claimed in claim 9.
